(19) United States
(12) Patent Application Publication
(10) Pub. No.: US 2016/0246966 A1
(43) Pub. Date: Aug. 25, 2016

(54) METHOD AND SYSTEM OF ASSESSING RISK ASSOCIATED WITH USERS BASED AT LEAST IN PART ON ONLINE PRESENCE OF THE USER

(71) Applicant: Vertafore, Inc., Bothell, WA (US)

(72) Inventors: Marwan Batrouni, Kirkland, WA (US); David L. Patten, Bothell, WA (US); Pascal J. Pinck, Bellevue, WA (US)

(21) Appl. No.: 14/630,509

(22) Filed: Feb. 24, 2015

(51) Int. Cl. G06F 21/60; G06Q 30/00; G06F 21/62

(52) U.S. Cl. CPC G06F 21/60; G06F 21/6245; G06Q 30/018

(57) ABSTRACT

A risk assessment system assesses risk associated with users based at least in part on online presence of the user. The risk assessment system includes at least one processor and at least one processor-readable storage medium that stores at least one of processor-executable instructions or data. Assessing user risk includes accessing publicly available online data specific to the first user and accessing privately available online data specific to the first user. The privately available online data is only available via authorization granted via the first user. Based at least in part on the accessed publicly and privately available online data for the first user, a respective value is generate specific to the first user for each of at least one subject matter index. The respective value indicates amount of risk associated with the first user based on a respective set of subject matter criteria for each subject matter index.

### BACKGROUND

1. Technical Field

The present disclosure generally relates to systems and methods for assessing risk of a user based at least in part on online presence of the user.

2. Description of the Related Art

Electronic user data, such as social networking and web browsing activity, health and financial records, consumer preferences, personal tastes and affinities, and personally identifiable information, are an ever growing commodity today. This ubiquitous electronic user data can be used in laudable ways, such as helping companies identify users that are more likely to be interested in a particular product or service. Unfortunately, however, this user data can also compromise the privacy of a user both through malicious and accidental disclosure of the data, and can lead to abuses by market actors. This holds true across industries and sectors, not least in the insurance marketplace where information, especially quantitative or quantifiable data points, represents a competitive advantage in terms of selling, marketing, and underwriting insurance products to clients or users.

The abundance of electronic user data provides an opportunity for the use of this data by both users and consumers of the data. Users are persons or entities having data about them present online through various sources, such as various online accounts held by the users. Consumers are parties or entities that would like to evaluate the data of a user in making an determination as to whether to enter into a business transaction with the user, such an insurance company making a determination whether to provide insurance to a given user. In this environment, security and privacy of users are threatened in new and continually evolving ways, making users extremely concerned about the security of their data and sharing of that data even though such sharing could benefit the users. Ways to protect individual users and the concerns of such users, whether those users are persons or organizations, while also allowing for the secure exchange of valuable user data with consumers of such data would have great benefits for both users and consumers.

### BRIEF SUMMARY

A method of operation in a risk assessment system to assess risk associated with users is based at least in part on online presence. The risk assessment system may include at least one processor and at least one processor-readable storage medium communicatively coupled to the at least one processor and that stores at least one of processor-executable instructions or data. The method may be summarized as including: accessing publicly available online data specific to a first user; accessing privately available online data specific to the first user, the privately available online data only available via authorization granted via the first user; based at least in part on the accessed publicly and privately available online data for the first user, generating, by the at least one processor, a respective value specific to the first user for each of at least one subject matter index, the respective value indicative of an amount of risk associated with the first user based on a respective set of subject matter criteria for the respective subject matter index.

Accessing publicly available online data specific to a first user may include at least one of: i) accessing information on a publicly accessible online account which was identified by the first user, or ii) accessing information on a publicly accessible online account which was not identified by the first user. Accessing privately available online data specific to the first user may also include at least one of: i) accessing information on a private online account for which the first user has granted access permission, or i) accessing information on a private online account for which the first user has provided at least one piece of information required to access the private online account. Generating a respective value specific to the first user for each of at least one subject matter index may include generating a respective value for at least one of: a cyber-privacy index based on a set of cyber-privacy criteria, a cyber-security index based on a set of cyber-security criteria, a government security clearance index based on a set of government security clearance criteria, a cyber-exposure index based on a set of cyber-exposure criteria, a cyber-footprint index based on a set of cyber-footprint criteria, or an electronic safety history index based on a set of historical electronic security criteria. Generating a respective value specific to the first user for each of at least one subject matter index may include generating a respective value for a lifestyle index based on a set of individual lifestyle criteria. Generating a respective value specific to the first user for each of at least one subject matter index may include generating a respective value based on subject matter criteria indicative of at least one of behaviors, traits, relationships, preferences, or activities as assessed from publicly and privately available online data. Generating a respective value specific to the first user for each of at least one subject matter index may include aggregating information from across a number of publically and privately available online resources. Generating a respective value specific to the first user for each of at least one subject matter index may further include for at least one piece of information, cross-checking the piece of information between at least two different ones of the publically and privately available online resources. Generating a respective value specific to the first user for each of at least one subject matter index may further include for at least one piece of information, determining at least one of: i) how recently the piece of information was made available, or ii) how old is the publically or privately available online resource from which the respective piece of information was derived; and assessing a reliability of the respective piece of information based on the determination regarding how recently the piece of information was made available, or how old is the publically or privately available online resource from which the respective piece of information was derived. Generating a respective value specific to the first user for each of at least one subject matter index may further include for at least one piece of information, assessing how extensively populated is the publically or privately available online resource from which the respective piece of information was derived, and assessing a reliability of the respective piece of information based on the assessment of how extensively populated is the publically or privately available online resource from which the respective piece of information was derived. Generating a respective value specific to the first user for each of at least one subject matter index may include aggregating information including postings and images from across a number of publically and privately available online resources. Generating a respective value specific to the first user for each of at least one subject matter index may include generating a respective value for a lifestyle index based on a set of individual lifestyle criteria based at least in part on online postings or images which represent the first user engaged in at least one of: i) an unhealthy behavior, or ii) a risky activity. Generating a respective value for a lifestyle index based on a set of individual lifestyle criteria may further include assessing an apparent frequency of at least one of: an unhealthy behavior, or a risky engaged in by the first user based at least in part on the online postings an images. The method may further include: receiving permission specification information, by the at least one processor, for the first user that specifies at least one level of permission to access at least the respective value specific to the first user for each of at least one subject matter index. Receiving permission specification information for the first user may include receiving permission specification information for the first user that specifies a first level of permission for access to a first subject matter index and a second level of permission for access to a second subject matter index, the second subject matter index different from the first subject matter index. Receiving permission specification information for the first user may include receiving permission specification information for the first user that specifies a first level of permission for access to a first subject matter index and a second level of permission for access to specific information from which the first subject matter index was derived. Receiving permission specification information for the first user may include receiving permission specification information for the first user from the first user that specifies a first level of permission for access to information based on at least one of: i) a defined context, ii) a defined purpose, or iii) a defined period of time. The method may further include: causing a presentation of a set of certification packages that are available to choose from. The method may further include: causing a presentation of a set of subject matter indices that are available to choose from. The method may further include: causing a presentation of at least one of: i) a set of certification packages that are available to choose, or ii) a set of subject matter indices that are available to choose from; and wherein receiving permission specification information includes receiving a selection of at least one of: i) one of the certification packages, or ii) one of subject matter indices. The method may further include: setting at least the first level of permission based at least in part of the received selection. The method may further include: receiving, by the at least one processor, a request by a content consumer for access to information associated with the first user, the content consumer different than the first user; and providing or denying the content consumer access to the information requested by the content consumer based at least in part on the received receiving permissions specification information for the first user, by the at least one processor. Receiving a request by a content consumer for access to information associated with the first user may include receiving a request by an insurance industry entity for information about a potential insured. Receiving a request by a content consumer for access to information associated with the first user may include receiving a request for the respective value of the at least one subject matter index. Receiving a request by a content consumer for access to information associated with the first user may include receiving a request for the respective value of the at least one certification package. Receiving a request by a content consumer for access to information associated with the first user may include receiving a request from the first user.

A risk assessment system to assess risk associated with users based at least in part on online presence may be summarized as including: at least one processor; at least one processor-readable storage medium communicatively coupled to the at least one processor and that stores at least one of processor-executable instructions or data that, when executed by the at least one processor, cause the at least one processor to function as a risk assessment system that: accesses publicly available online data specific to a first user; accesses privately available online data specific to the first user, the privately available online data only available via authorization granted via the first user; generates, based at least in part on the accessed publicly and privately available online data for the first user, a respective value specific to the first user for each of at least one subject matter index, the respective value indicative of an amount of risk associated with the first user based on a respective set of subject matter criteria for the respective subject matter index.

The processor-executable instructions or data that cause the at least one processor to access publicly available online data specific to the first user may further cause the at least one processor to: i) access information on a publicly accessible online account which was identified by the first user, or ii) access information on a publicly accessible online account which was not identified by the first user. The processor-executable instructions or data that cause the at least one processor to access publicly available online data specific to the first user may further cause the at least one processor to: i) access information on a private online account for which the first user has granted access permission, or i) access information on a private online account for which the first user has provided at least one piece of information required to access the private online account. The processor-executable instructions or data that cause the at least one processor to generate a respective value specific to the first user for each of at least one subject matter index may further cause the at least one processor to generate a respective value for at least one of: a cyber-privacy index based on a set of cyber-privacy criteria, a cyber-security index based on a set of cyber-security criteria, a government security clearance index based on a set of government security clearance criteria, a cyber-exposure index based on a set of cyber-exposure criteria, a cyber-footprint index based on a set of cyber-footprint criteria, or an electronic safety history index based on a set of historical electronic security criteria. The processor-executable instructions or data that cause the at least one processor to generate a respective value specific to the first user for each of at least one subject matter index may further cause the at least one processor to generate a respective value for a lifestyle index based on a set of individual lifestyle criteria. The processor-executable instructions or data that cause the at least one processor to generate a respective value specific to the first user for each of at least one subject matter index may further cause the at least one processor to generate a respective value based on subject matter criteria indicative of at least one of behaviors, traits, relationships, preferences, or activities as assessed from publicly and privately available online data. The processor-executable instructions or data that cause the at least one processor to generate a respective value specific to the first user for each of at least one subject matter index may further cause the at least one processor to aggregate information from across a number of publically and privately available online resources. The processor-executable instructions or data that cause the at least one processor to generate a respective value specific to the first user for each of at least one subject matter index may further cause the at least one processor to include for at least one piece of information, cross-checking the piece of information between at least two different ones of the publically and privately available online resources. The processor-executable instructions or data that cause the at least one processor to generate a respective value specific to the first user for each of at least one subject matter index may further cause the at least one processor to include for at least one piece of information, determining at least one of: i) how recently the piece of information was made available, or ii) how old is the publically or privately available online resource from which the respective piece of information was derived; and assessing a reliability of the respective piece of information based on the determination regarding how recently the piece of information was made available, or how old is the publically or privately available online resource from which the respective piece of information was derived. The processor-executable instructions or data that cause the at least one processor to generate a respective value specific to the first user for each of at least one subject matter index may further cause the at least one processor to include for at least one piece of information, assessing how extensively populated is the publically or privately available online resource from which the respective piece of information was derived, and assessing a reliability of the respective piece of information based on the assessment of how extensively populated is the publically or privately available online resource from which the respective piece of information was derived. The processor-executable instructions or data that cause the at least one processor to generate a respective value specific to the first user for each of at least one subject matter index may further cause the at least one processor to aggregate information including postings and images from across a number of publically and privately available online resources. The processor-executable instructions or data that cause the at least one processor to generate a respective value specific to the first user for each of at least one subject matter index may further cause the at least one processor to generate a respective value for a lifestyle index based on a set of individual lifestyle criteria based at least in part on online postings or images which represent the first user engaged in at least one of: i) an unhealthy behavior, or ii) a risky activity. The processor-executable instructions or data that cause the at least one processor to generate a respective value for a lifestyle index based on a set of individual lifestyle criteria may further cause the at least one processor to assess an apparent frequency of at least one of: an unhealthy behavior, or a risk engaged in by the first user based at least in part on the online postings and images. The processor-executable instructions or data may further cause the at least one processor to: receive permission specification information for the first user that specifies at least one level of permission to access at least the respective value specific to the first user for each of at least one subject matter index. The processor-executable instructions or data that cause the at least one processor to receive permission specification information for the first user may further cause the at least one processor to receive permission specification information for the first user that specifies a first level of permission for access to a first subject matter index and a second level of permission for access to a second subject matter index, the second subject matter index different from the first subject matter index. The processor-executable instructions or data that cause the at least one processor to receive permission specification information for the first user may further cause the at least one processor to receive permission specification information for the first user that specifies a first level of permission for access to a first subject matter index and a second level of permission for access to a specific information from which the first subject matter index was derived. The processor-executable instructions or data that cause the at least one processor to receive permission specification information for the first user may further cause the at least one processor to receive permission specification information for the first user from the first user that specifies a first level of permission for access to information based on at least one of: i) a defined context, ii) a defined purpose, or iii) a defined period of time. The processor-executable instructions or data may further cause the at least one processor to: cause a presentation of a set of certification packages that are available to choose from. The processor-executable instructions or data may further cause the at least one processor to: cause a presentation of a set of subject matter indices that are available to choose from. The processor-executable instructions or data may further cause the at least one processor to: cause a presentation of at least one of: i) a set of certification packages that are available to choose, or ii) a set of subject matter indices that are available to choose from; and wherein receiving permission specification information includes receiving a selection of at least one of: i) one of the certification packages, or ii) one of subject matter indices. The processor-executable instructions or data may further cause the at least one processor to: set at least the first level of permission based at least in part of the received selection. The processor-executable instructions or data may further cause the at least one processor to: receive a request by a content consumer for access to information associated with the first user, the content consumer different than the first user; and provide or deny the content consumer access to the information requested by the content consumer based at least in part on the received permissions specification information for the first user. The processor-executable instructions or data that cause the at least one processor to receive a request by a content consumer for access to information associated with the first user may further cause the at least one processor to receive a request by an insurance industry entity for information about a potential insured. The processor-executable instructions or data that cause the at least one processor to receive a request by a content consumer for access to information associated with the first user may further cause the at least one processor to receive a request for the respective value of the at least one subject matter index. The processor-executable instructions or data that cause the at least one processor to receive a request by a content consumer for access to information associated with the first user may further cause the at least one processor to receive a request for the respective value of the at least one certification package. The processor-executable instructions or data that cause the at least one processor to receive a request by a content consumer for access to information associated with the first user may further cause the at least one processor to receive a request from the first user.

A method of assessing online exposure of a user may be summarized as including: receiving user selection data defining the types of user data to be included in assessing online exposure of the user; collecting online user data based upon the user selection data; generating at least one user index based on the collected online user data, each user index providing an indication of an aspect of the online exposure of the user while maintaining the anonymity of the user; receiving user authorization data that establishes permissions defining access to the generated user indexes; and providing or denying access to each generated user index based upon the user authorization data.

Receiving user selection data defining the types of user data to be included in assessing online exposure of the user may include receiving a selection of one of a plurality of user certification packages, each certification package defining corresponding online user data to be collected. Receiving a selection of one of a plurality of user certification packages may further include selecting one of: a first level certification package that includes only publicly available online user data; a second level certification package that includes the data of the first level certification package and further includes data of user social networking accounts; a third level certification package that includes the data of the second level certification package and further includes any user email accounts; and a fourth level certification package that includes the data of the third level certification package and further includes any user accounts on job-related Websites. These certification packages are presented by way of example. Other types of certification packages including other types of data may be used in place of or in combination with these examples. Selecting one of the first, second third and fourth level certification packages may further include selecting the certification package based upon a plurality of indices associated with certification packages, each of the indices relating to a subject matter category for the user. Selecting the certification package based upon a plurality of indices associated with certification packages may further include selecting the certification package based upon subject matter categories for the user including a user privacy category, a user security category, a user health category, a user government level security clearance category, and a user general cyber presence category. Receiving user authorization data that establishes permissions defining access to the generated user indexes may include establishing permissions that grant identified third parties access to the indices and deny access to all other third parties. Receiving user authorization data that establishes permissions defining access to the generated user indexes may include receiving user authorization date from an individual and wherein establishing permissions that grant identified third parties access to the indices and deny access to all other third parties comprises establishing permissions that grant permission to one or more insurance entities. The method may further include: providing each generated user index to the user; and providing the user with instructions on how to improve the value of each user index. The method may further include: accessing the generated indices; and using the generated indices to assess the risk to a third party of providing insurance to the user. Using the generated indices to assess the risk to the third party may include simulating a financial impact on the third party for indices having specific values.

A risk assessment system to assess risk associated with users based at least in part on online presence may be summarized as including: at least one processor; at least one processor-readable storage medium communicatively coupled to the at least one processor and that stores at least one of processor-executable instructions or data that, when executed by the at least one processor, cause the at least one processor to function as a risk assessment system that: receives user selection data defining the types of user data to be included in assessing online exposure of the user; collects online user data based upon the user selection data; generates at least one user index based on the collected online user data, each user index providing an indication of an aspect of the online exposure of the user while maintaining the anonymity of the user; receives user authorization data that establishes permissions defining access to the generated user indexes; and provides or denies access to each generated user index based upon the user authorization data.

The processor-executable instructions or data that cause the at least one processor to receive user selection data defining the types of user data to be included in assessing online exposure of the user may further cause the at least processor to receive a selection of one of a plurality of user certification packages, each certification package defining corresponding online user data to be collected. The processor-executable instructions or data that cause the at least one processor to receive a selection of one of a plurality of user certification packages may further cause the at least one processor to select one of: a first level certification package that includes only publicly available online user data; a second level certification package that includes the data of the first level certification package and further includes data of user social networking accounts; a third level certification package that includes the data of the second level certification package and further includes any user email accounts; and a fourth level certification package that includes the data of the third level certification package and further includes any user accounts on job-related Websites. The processor-executable instructions or data that cause the at least one processor to select one of the first, second third and fourth level certification packages may further cause the at least one processor to select the certification package based upon a plurality of indices associated with certification packages, each of the indices relating to a subject matter category for the user. The processor-executable instructions or data that cause the at least one processor to select the certification package based upon a plurality of indices associated with certification packages may further cause the at least one processor to select the certification package based upon subject matter categories for the user including a user privacy category, a user security category, a user health category, a user government level security clearance category, and a user general cyber presence category. These subject matter categories are presented by way of example and other subject matter categories may be used in place of or in addition to these examples. The processor-executable instructions or data that cause the at least one processor to receive user authorization data that establishes permissions defining access to the generated user indices may further cause the at least one processor to establish permissions that grant identified third parties access to the indices and deny access to all other third parties. The processor-executable instructions or data that cause the at least one processor to receive user authorization data that establishes permissions defining access to the generated user indices may further cause the at least one processor to receive user authorization data from an individual and wherein the processor-executable instructions or data that cause the at least one processor to establish permissions that grant identified third parties access to the indices and deny access to all other third parties further cause the at least one processor to establish permissions that grant access to one or more insurance entities. The processor-executable instructions or data may further cause the at least one processor to: provide each generated user index to the user; and provide the user with instructions on how to improve the value of each user index. The processor-executable instructions or data may further cause the at least one processor to: assess the generated indices; and use the assessment of the indices to assess the risk to a third party of providing insurance to the user. The processor-executable instructions or data that cause the at least one processor to use the generated indices to assess the risk to the third party may further cause the at least one processor to simulate a financial impact on the third party for indices having specific values.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a risk assessment system for assessing risk of a user based at least in part on online presence of the user according to one embodiment of the present disclosure.

FIG. 2 is a schematic diagram of a network for implementing the risk assessment system of FIG. 1 according to one illustrated embodiment.

FIG. 3 is a functional block diagram of a computing system suitable for use as the host system or other computing system of FIG. 2, according to one illustrated embodiment.

FIG. 4A is a flow diagram of a process illustrating the overall operation of the risk assessment system of FIGS. 1-3 according one illustrated embodiment.

FIG. 4B illustrates a table designated Table 1 that shows by way of example several subject matter categories and several subject matter indices that may be utilized and generated, respectively, by the risk assessment system of FIGS. 1-3.

FIG. 5A is a flow diagram illustrating in more detail a process for the generation of the subject matter indices for a user according to one embodiment of the risk assessment system of FIGS. 1-4.

FIG. 5B illustrates a table designated Table 2 that shows example certification packages and the corresponding families of subject matter indices for each package and for each subject matter category utilized by the risk assessment system of FIG. 5A according to this illustrated embodiment.

FIG. 6 is a flow diagram illustrating in more detail one embodiment of a process through which a content consumer such as an insurance company requests information such as the generated subject matter indices from the risk assessment system of FIGS. 1-3.

FIG. 7 is a more detailed functional block diagram of the risk assessment system of FIG. 1 according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures and/or standards associated with computer systems, server computers, HyperText Markup Language (HTML), Cascade Style Sheets (CSS), Web page coding, properties of colors, and communications networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Embodiments of the present disclosure are directed to systems and methods of a risk assessment system that cross-references sources of public and private data about a user, such as an individual or legal entity like a corporation. The risk assessment system functions as an information broker between the user and a content consumer, such as an insurance company, which desires to obtain information about the user for making a determination regarding the user, like whether to provide insurance to the user. The risk assessment system also generates subject matter indices having values that “rate” the level of various risks associated with the user. In this way, the system models threats associated with the user using multiple data sources, such as sources of public and private data about the user, which may include social networking data for the user. The risk assessment system generates the subject matter indicates by analyzing aggregate data from the accessed sources of public and private data about the user. A user may also provide permission specification information to the risk assessment system which allows the system to grant and deny permissions to content consumers to access specific information or subject matter indices of the user. These permissions may limit such access by a content consumer to specific contexts and specific purposes and may also limit access to specific periods of time such as the duration for which the content consumer may have access.

A user may also simulate the affects that taking various actions would have on the values of the subject matter indices associated with the user. The risk assessment system may also provide the user with guidance as to specific actions to take to improve the values of the subject matter. In this way, through the risk assessment system a user may reduce their risk resulting from their online activities and also safely and anonymously transmit data to content consumers, such as insurance agencies or carriers. Such risk reductions and the resulting improved values of subject matter indices may enable the user to obtain more favorable policy terms from an insurance company, for example, and without compromising the privacy of the user.

For content consumers, such as insurance agencies or carriers, the risk assessment system provides a mechanism to more effectively determine an appropriate level of risk associated with a user based, at least in part, on the user's behaviors, traits, relationships, preferences and activities as indicated by the accessed sources of public and private data for the user. Such private sources of data are otherwise unobtainable by the content consumer, absent express disclosure of such data by the user to the content consumer, which provides no privacy for the user. In contrast, the risk assessment system makes such private data of a user available to the content consumer in a privacy-protected form, such as through the disclosure of the generated subject matter indices. Moreover, the disclosure of this private data, such as the generated subject matter indices for the user, is affirmatively authorized by the user via the risk assessment system. The content consumer, such as an insurance company, may also simulate a financial impact on the insurance company for providing insurance to a user having subject matter indices having specific values.

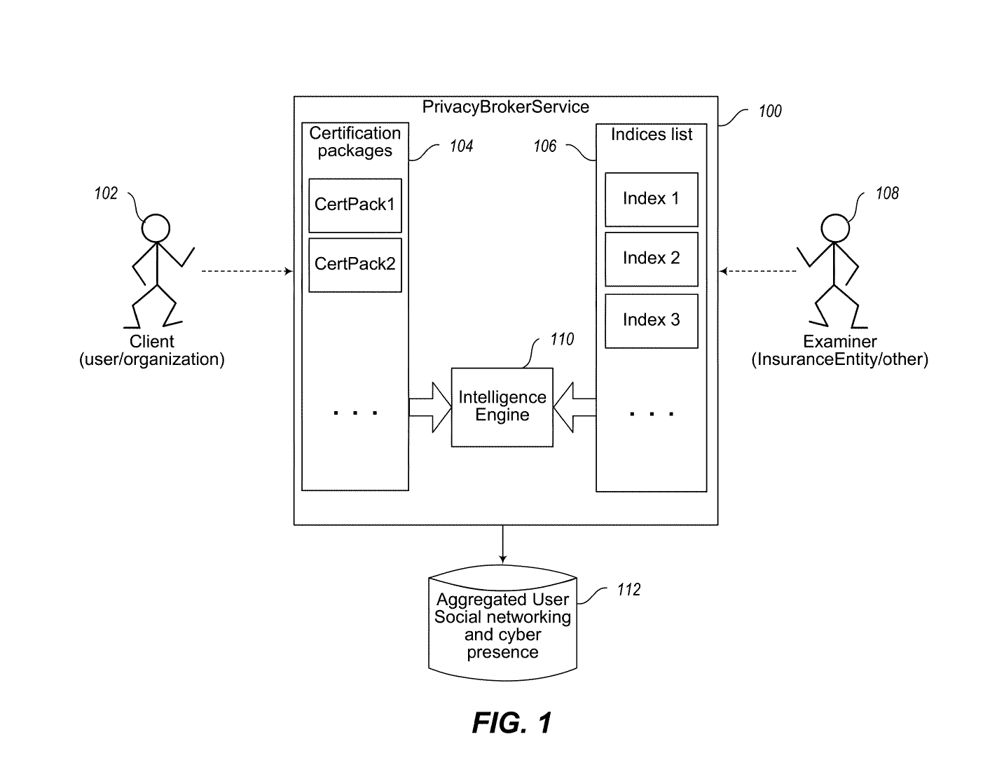

FIG. 1 is a schematic diagram of a risk assessment system 100 for assessing risk of a client or user 102 based at least in part on online presence of the client or user according to one embodiment of the present disclosure. In operation, the risk assessment system 100 initially presents the user 102 with a set of certification packages 104 that are available to choose from and/or a set of subject matter indices 106 that are available for the user to choose from for generation by the risk assessment system. The risk assessment system 100 then receives from the user 102 permissions specification information, which includes a selection of one of the certification packages 104 and/or the subject matter indices 106 to be generated by the system. The permissions specification information for the first user may also include information about whether to provide or deny access by a content consumer 108 to information about the first user, such as the generated subject matter indices 106 for the user. The content consumer 108 may, for example, be an insurance company, and may request from the risk assessment system 100 information about the first user, such as the generated subject matter indices 106 for the user. In the risk assessment system 100, an intelligence engine 110 operates in combination with a database 112 to generate the subject matter indices 106. The database 112 stores global rules and models that are generated from information provided by users 102 of the system 100, and these rules and models are used by the intelligence engine 110 in generating the subject matter indices. The operation of the intelligence engine 110 and database 112 will be described in more detail below.

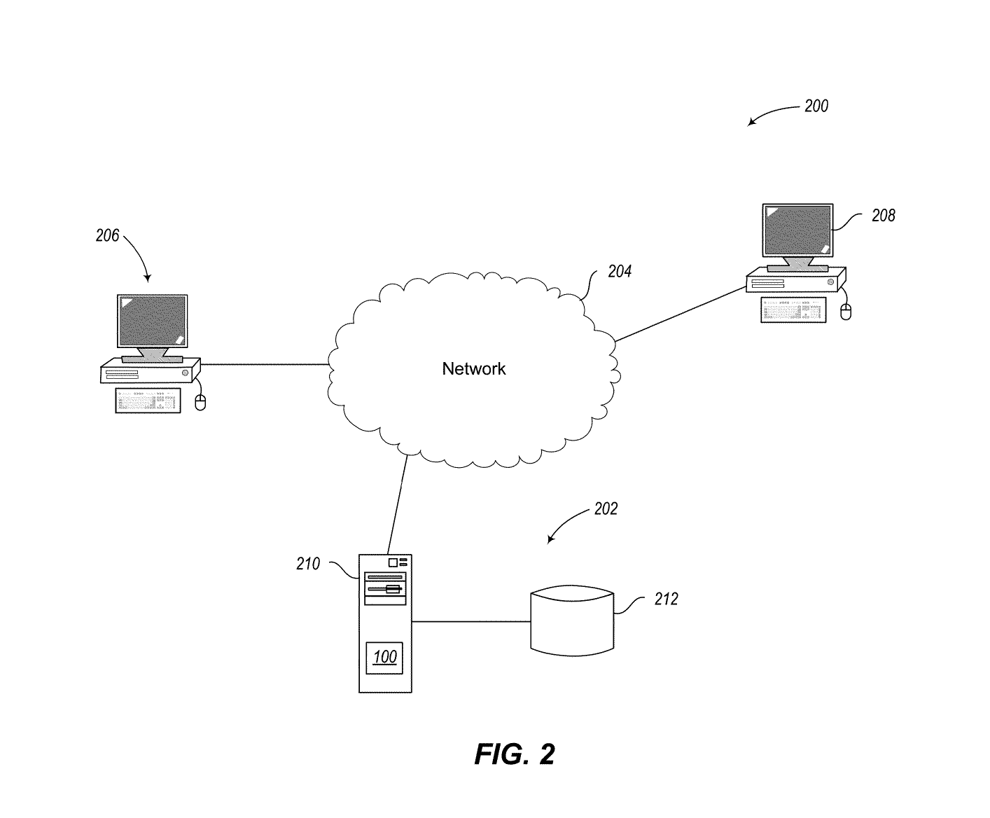

FIG. 2 is a schematic diagram of a networked environment 200 for implementing the risk assessment system 100 of FIG. 1 of according to one illustrated embodiment. The networked environment 200 includes one or more host system 202 that hosts the risk assessment system 100 and that is communicatively coupled through one or more networks 204 to conventional computing systems 206 and 208. The computer system 206 represents a computer system utilized by the user 102 (FIG. 1) to access via the network 204 the risk assessment system 100 running on the host system 202. Similarly, the computer system 208 represents the computer system utilized by a content consumer 108 (FIG. 1) to access via the network 204 the risk management system 100 running on host system 202.

The host system 202 may include one or more computing systems 210 and one or more storage devices or databases 212. The computing system 210 may take any of a variety of forms, for example, personal computers, mini-computers, work stations, or main frame computers. The computing system 210 may, where the network 204 includes the Internet for example, take the form of a server computer executing server software. The storage or database 212 can take a variety of forms, including one or more hard disks or RAID drives, CD/ROMs, FLASH drives, or other mass storage devices.

The network 204 can take a variety of forms, for example one or more local area networks (LANs), wide area networks (WANs), wireless LANs (WLANs), and/or wireless WANs (WWANs). The network 204 may employ packet switching or any other type of transmission protocol. The network 204 may, for example, take the form of the Internet or Worldwide Web portion of the Internet. The network 204 may take the form of public switched telephone network (PSTN) or any combination of the above, or other networks. The computer systems 206, 208 may include may take any of a variety of forms, for example, personal computers, mini-computers, work stations, or main frame computers.

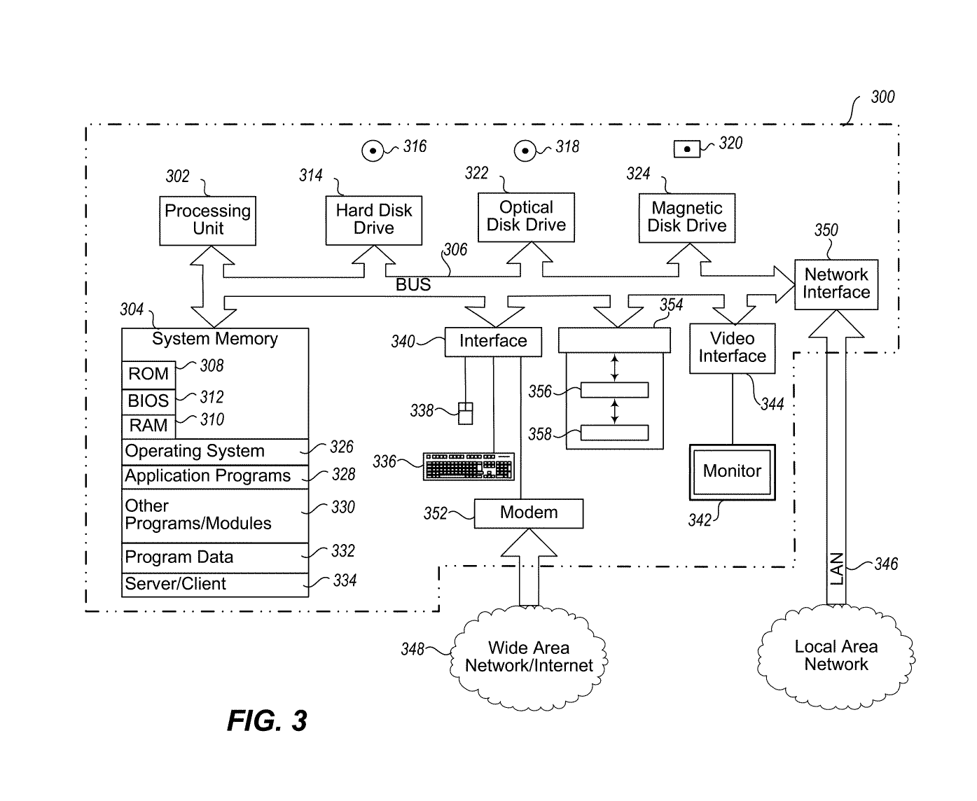

FIG. 3 is a functional block diagram of a computing system 300 suitable for use as the host system 202 or other computing systems 206, 208 of FIG. 2, according to one illustrated embodiment. FIG. 3 shows a conventional personal computer referred to herein as computing system 300 that may be appropriately configured to function as either the computing system 210 of the host system 202 or the computing systems 206, 208 of FIG. 2. The computing system 300 includes a processing unit 302, a system memory 304 and a system bus 306 that couples various system components including the system memory 304 to the processing unit 302. The processing unit 302 may be any logical processing unit, such as one or more central processing units (CPUs), digital signal processors (DSPs), application-specific integrated circuits (ASICs), field programmable gate arrays (FPGAs), etc. Unless described otherwise, the construction and operation of the various blocks shown in FIG. 3 are of conventional design. As a result, such blocks need not be described in further detail herein, as they will be understood by those skilled in the relevant art.

The system bus 306 can employ any known bus structures or architectures, including a memory bus with memory controller, a peripheral bus, and/or a local bus. The system memory 304 includes ROM 308 and RAM 310. A basic input/output system (“BIOS”) 312, which can form part of the ROM 308, contains basic routines that help transfer information between elements within the computing system 300, such as during startup.

The computing system 300 also includes one or more spinning media memories such as a hard disk drive 314 for reading from and writing to a hard disk 316, and an optical disk drive 322 and a magnetic disk drive 324 for reading from and writing to removable optical disks 318 and magnetic disks 320, respectively. The optical disk 318 can be a CD-ROM, while the magnetic disk 320 can be a magnetic floppy disk or diskette. The hard disk drive 314, optical disk drive 322 and magnetic disk drive 324 communicate with the processing unit 302 via the bus 306. The hard disk drive 314, optical disk drive 322 and magnetic disk drive 324 may include interfaces or controllers coupled between such drives and the bus 306, as is known by those skilled in the relevant art, for example via an IDE (i.e., Integrated Drive Electronics) interface. The drives 314, 322 and 324, and their associated computer-readable media 316, 318 and 320, provide nonvolatile storage of computer-readable instructions, data structures, program modules and other data for the computing system 300. Although the depicted computing system 300 employs hard disk 316, optical disk 318 and magnetic disk 320, those skilled in the relevant art will appreciate that other types of spinning media memory computer-readable media may be employed, such as digital video disks (“DVDs”), Bernoulli cartridges, etc. Those skilled in the relevant art will also appreciate that other types of computer-readable media that can store data accessible by a computer may be employed, for example, non-spinning media memories such as magnetic cassettes, flash memory cards, RAMs, ROMs, smart cards, etc.

Program modules can be stored in the system memory 304, such as an operating system 326, one or more application programs 328, other programs or modules 330, and program data 332. The applications programs 328 may include one or more custom programs that may be utilized in providing access via the network 204 to the risk assessment system 100. The system memory 304 also includes one or more communications programs 334 for permitting the computing system 300 to access and exchange data with sources such as websites of the Internet, corporate intranets, or other networks, as well as other server applications on server computers. The communications program 334 may take the form of one or more server programs. Alternatively, or additionally, the communications program may take the form of one or more browser programs. The communications program 334 may be markup language based, such as hypertext markup language (“HTML”), Extensible Markup Language (XML) or Wireless Markup Language (WML), and operate with markup languages that use syntactically delimited characters added to the data of a document to represent the structure of the document. A number of Web clients or browsers are commercially available such as NETSCAPE NAVIGATOR® from America Online, and INTERNET EXPLORER® available from Microsoft Corporation of Redmond Wash.

While shown in FIG. 3 as being stored in the system memory 304, the operating system 326, application programs 328, other program modules 330, program data 332 and communications program 334 can be stored on the hard disk 316 of the hard disk drive 314, the optical disk 318 of the optical disk drive 322 and/or the magnetic disk 320 of the magnetic disk drive 324.

A user 102 (FIG. 1) can enter commands and information to the computing system 300 through input devices such as a keyboard 336 and a pointing device such as a mouse 338. Other input devices can include a microphone, joystick, game pad, scanner, button, key, microphone with voice recognition software, etc. These and other input devices are connected to the processing unit 302 through an interface 340 such as a serial port interface that couples to the bus 306, although other interfaces such as a parallel port, a game port or a universal serial bus (“USB”) can be used. A monitor 342 or other display devices may be coupled to the bus 306 via video interface 344, such as a video adapter. The computing system 300 can include other output devices such as speakers, printers, etc.

The computing system 300 can operate in a networked environment 200 (FIG. 2) using logical connections to one or more remote computers, such as the host system 202. The computing system 300 may employ any known means of communication, such as through a local area network (“LAN”) 346 or a wide area network (“WAN”) or the Internet 348. Such networking environments are well known in enterprise-wide computer networks, intranets, extranets, and the Internet.

When used in a LAN networking environment, the computing system 300 is connected to the LAN 346 through an adapter or network interface 350 (communicatively linked to the bus 306). When used in a WAN networking environment, the computing system 300 often includes a modem 352 or other device for establishing communications over the WAN/Internet 348. The modem 352 is shown in FIG. 3 as communicatively linked between the interface 340 and the WAN/Internet 348. In a networked environment, program modules, application programs, or data, or portions thereof, can be stored in a server computer (not shown). Those skilled in the relevant art will readily recognize that the network connections shown in FIG. 3 are only some examples of establishing communications links between computers, and other communications links may be used, including wireless links.

The computing system 300 may include one or more interfaces such as slot 354 to allow the addition of devices 356, 358 either internally or externally to the computing system 300. For example, suitable interfaces may include ISA (i.e., Industry Standard Architecture), IDE, PCI (i.e., Personal Computer Interface) and/or AGP (i.e., Advance Graphics Processor) slot connectors for option cards, serial and/or parallel ports, USB ports (i.e., Universal Serial Bus), audio input/output (i.e., I/O) and MIDI/joystick connectors, and/or slots for memory.

The term “computer-readable medium” as used herein refers to any medium that participates in providing instructions to processing unit 302 for execution. Such a medium may take many forms, including but not limited to, non-volatile media, volatile media, and transmission media. Non-volatile media includes, for example, hard, optical or magnetic disks 316, 318, 320, respectively. Volatile media includes dynamic memory, such as system memory 304. Transmission media includes coaxial cables, copper wire and fiber optics, including the wires that comprise system bus 306. Transmission media can also take the form of acoustic or light waves, such as those generated during radio wave and infrared data communications.

Common forms of computer-readable media include, for example, floppy disk, flexible disk, hard disk, magnetic tape, or any other magnetic medium, CD-ROM, any other optical medium, punch cards, paper tape, any other physical medium with patterns of holes, RAM, PROM, EPROM, EEPROM, FLASH memory, any other memory chip or cartridge, a carrier wave as described herein, or any other medium from which a computer can read.

Various forms of computer readable media may be involved in carrying one or more sequences of one or more instructions to processing unit 302 for execution. For example, the instructions may initially be carried on a magnetic disk of a remote computer. The remote computer can load the instructions into its dynamic memory and send the instructions over a telephone line using a modem. A modem 352 local to computer system 300 can receive the data on the telephone line and use an infrared transmitter to convert the data to an infrared signal. An infrared detector coupled to the system bus 306 can receive the data carried in the infrared signal and place the data on system bus 306. The system bus 306 carries the data to system memory 304, from which processing unit 302 retrieves and executes the instructions. The instructions received by system memory 304 may optionally be stored on a storage device either before or after execution by processing unit 302.

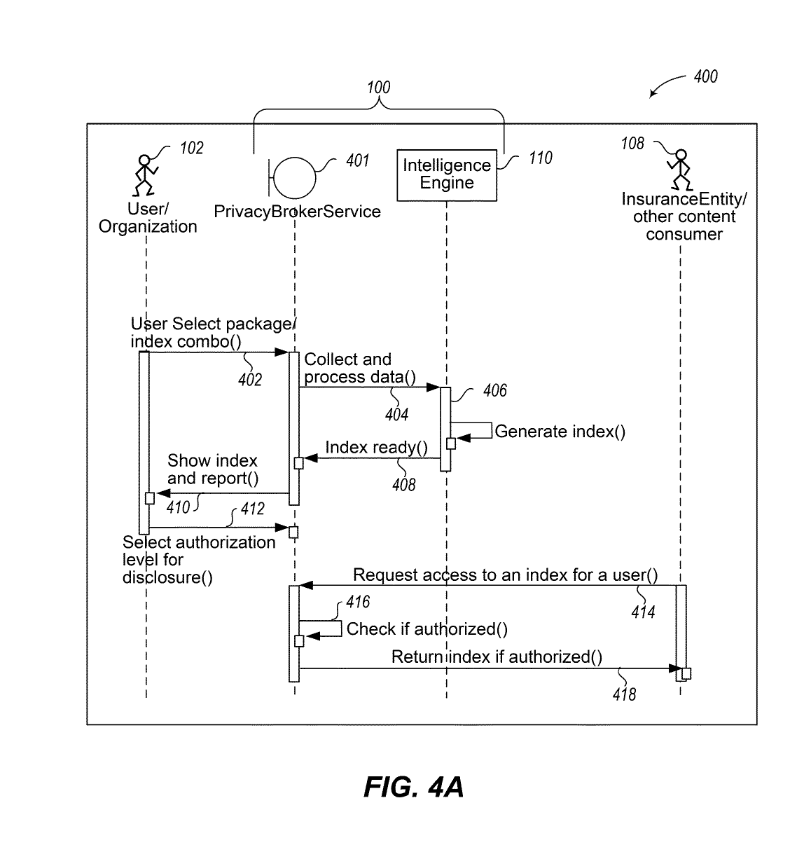

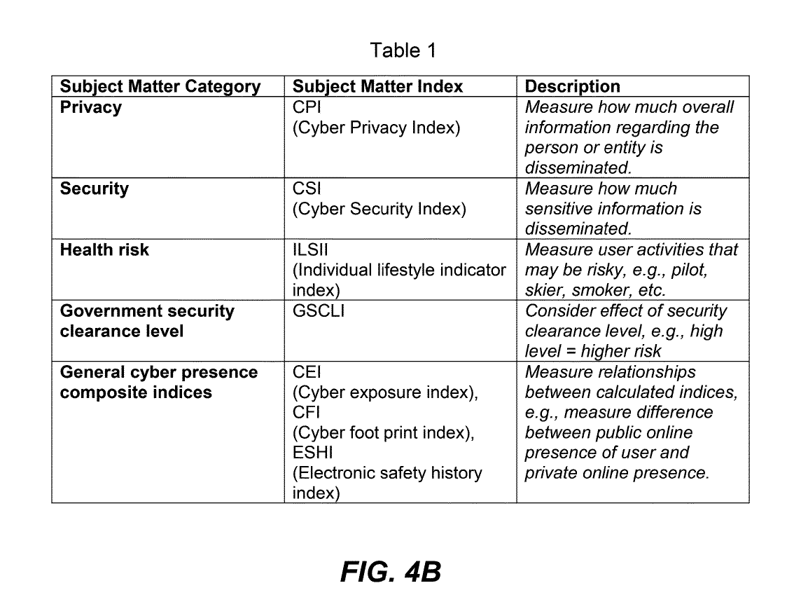

FIG. 4A is a flow diagram of a process 400 illustrating the overall operation of the risk assessment system 100 of FIGS. 1-3 according one illustrated embodiment. This process 400 will now be described in more detail with reference to FIG. 1 and FIGS. 4A and 4B. On the left side of FIG. 4A are illustrated operations between the user 102 and the risk assessment system 100 while the right side of the figure illustrates operations between a content consumer 108 and the risk assessment system. The middle portion of the figure shows operations performed by the risk assessment system 100 responsive to input from either the user 102 or content consumer 108. More specifically, the two vertical dashed lines in the middle of the figure indicate two of the functions performed by the risk assessment system. The left middle vertical line represents the privacy and broker functionality of the risk assessment system 100, which is indicated as privacy and broker service 401 in the figure. The right middle vertical line represents the analysis and generation functions of the risk assessment system performed by the intelligence engine 110.

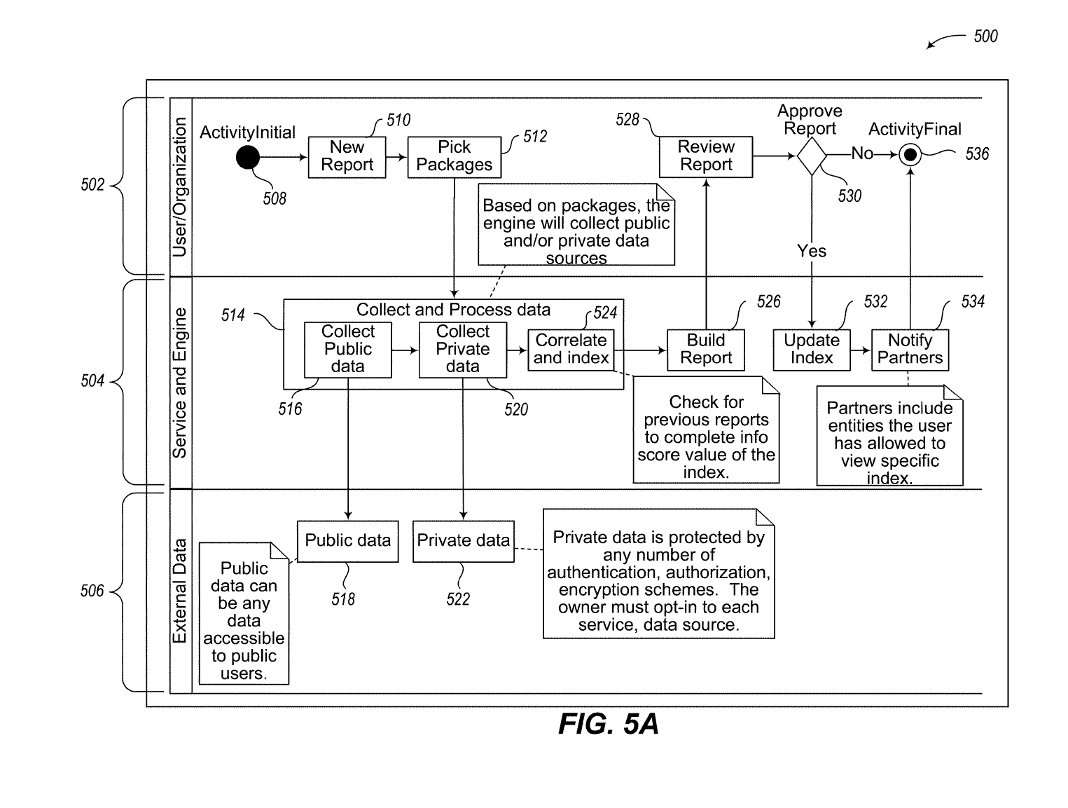

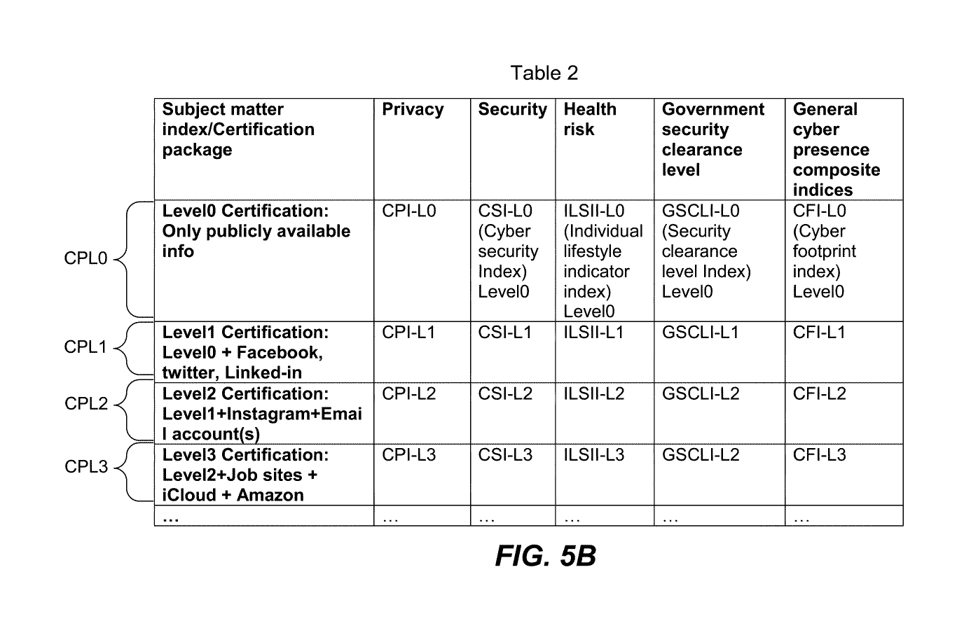

The process 400 starts at an initial selection operation 402 in which the user 102 accesses the risk assessment system 100 and is presented with options to select a certification package or subject matter indices that the user desires to use in assessing the risk of the user. A subject matter index is a scoring parameter that has a value that indicates a measurement of the subject matter being analyzed. These subject matter indices may be based on heuristics, and if so the value of the subject matter index provides more of a probabilistic measurement regarding the related subject matter than a precise, hard value. A certification package is a selected consent by the user 102 for the risk assessment system 100 to access a set of online accounts of the user for the purpose of evaluating and determining one or more specific subject matter indices for the user. In one embodiment, the certification packages are designated through level designations (e.g., level 0, level 1, level 2, and so on) where each level has a corresponding depth of information gathering that increases with increasing level. Examples of certification packages and the depth of information gathering for varying levels of packages will be discussed in more detail below with reference to FIG. 5B.

Before describing the overall process 400 in more detail, sample subject matter categories and subject matter indices will first be described in more detail with reference to FIG. 4B. FIG. 4B illustrates a table designated Table 1 that shows by way of example several subject matter categories and several subject matter indices that may be utilized and generated, respectively, by the risk assessment system 100. A subject matter category corresponds to an area of interest that is the subject of evaluation for the user 102 by the risk assessment system 100. Each row of Table 1 represents a corresponding subject matter category. Thus, in the example of FIG. 4B there are five subject matter categories utilized by the risk assessment system 100. The five subject matter categories in Table 1 shown in the left column of the table are: 1) privacy; 2) security; 3) health risk; 4) government security clearance level; and 5) general cyber presence composite indices. Other subject matter categories may, of course, be utilized by the risk assessment system 100 and FIG. 4B is merely an example of some possible categories.

Five subject matter indices are shown in the middle column of Table 1 and are as follows: 1) cyber privacy index (CPI); 2) cyber security index (CSI); 3) individual life style indicator index (ILSII); 4) government security clearance level index (GSCLI); and 5) three general cyber presence composite indices, namely a cyber exposure index (CEI), cyber foot print index (CFI), and electronic safety history index (ESHI). The right column of Table 1 briefly describes each of the subject matter categories. Although only a single one of each index is shown for each subject matter category in Table 1, each subject matter category actually includes a group or family of the corresponding subject matter index, where each member of the family corresponds to a different certification package that may be selected by the user 102, as will be described in more detail below with reference to FIG. 5B.

Returning now to the process 400 of FIG. 4, in the initial operation 402 the risk management system 100 presents the user 102 with options as to selections the user can make, such as by providing Web pages through which the user may select the desired certification package or subject matter indices to be generated. Once the user 102 has made this selection in operation 402, the process proceeds to operation 404 and the risk assessment system 100 collects and processes public and private data corresponding to the selections made by the user 102 in operation 402. The privacy broker service 401 then supplies the collected and processed data from operation 404 to the intelligence engine 110 which, in turn, generates in operation 406 corresponding subject matter indices. Once the required indices have been generated they are supplied to service 401 in operation 408 and are then provided to the user 102 along with a report summarizing or providing comments on the indices in operation 410.

The user 102 may then review may then review the generated indices and the associate report from operation 410, and thereafter provide permission specification information that specifies permissions that enable selected content consumers to access the indices, or which sets permission levels that enable certain content providers to access the indices. The operation 412 terminates the interaction or utilization by the user 102 of the risk assessment system 100.

In operation 414, a content consumer 108 accesses the risk assessment system 100, identifies a user 102, and requests access to the subject matter indices generated for the user. The process 400 then determines in operation 416 whether the given content consumer accessing the system 100 is authorized to access the requested indices. Access is granted or denied based on the identities of the content consumer 108 and the user 102 along with the permission specification information provided by the user 102 in operation 412. If the determination in operation 418 indicates the content consumer 108 is authorized to access the requested subject matter indices for the user 102, then the system 100 provides the generated indices to the user. Conversely, when the determination in operation 418 indicates the content consumer 108 is not authorized to access the requested subject matter indices, the system 100 does not provide the indices to the consumer. In this situation, the system 100 would also typically provide to the content consumer 108 in operation 418 a notification that the consumer is not authorized access the indices for the specified user 102.

In one embodiment, the permission specification information provided by the user 102 in operation 412 specifies at least one level of permission to access at least the respective value specific to the user 102 for each of at least one subject matter index. In another embodiment, the user 102 may via the permission specification information provide a first level of permission for access to a first subject matter index or group of indices and a second level of permission for access to a second different subject matter index or group of indices. In still another embodiment, the permission specification information from the user 102 specifies a first level of permission for access to a first subject matter index and a second level of permission for access to specific information from which the first subject matter index was generated. In another embodiment, the permission specification information specifies a first level of permission for access to information based on at least one of a defined context, a defined purpose, or a defined period of time.

FIG. 5A is a flow diagram illustrating in more detail a process 500 for the generation of the subject matter indices for a user 102 according to one embodiment of the risk assessment system of FIGS. 1-4. A top portion 502 of FIG. 5A illustrates interactions between the user 102 and the risk management system 100. A middle portion 504 of FIG. 5A illustrates operations performed by the privacy broker service 401 and intelligence engine 110 components of the system 100. A bottom portion 506 of FIG. 5A shows the public and private data accessed by the service 401 and intelligence engine 110 components in generating the subject matter indices for the user 102, where this is data external to the system 100 and includes the data on various public and private networks that are accessed by the system 100.

Before describing the process 500 in more detail, examples of the certification packages utilized in the embodiment of FIG. 5A will first be described with reference to FIG. 5B. FIG. 5B illustrates a table designated Table 2 that shows by way of example certification packages and the corresponding families of subject matter indices and subject matter categories utilized by the risk assessment system 100 according to the embodiment of FIG. 5A. Each row in Table 2 shows a respective certification package that may be selected by the user 102. The different certification packages are designated through different level designations, with the certification package in the first row is designated CPL0 for the level 0 certification package. The certification package in the next row is designated CPL1 for the level 1 certification package and is followed by packages CPL2 and CPL3 for the final two certification packages. Each level L0-L3 indicates a corresponding depth of information gathering that occurs for that level, with the depth of information gathering increasing for increasing levels.

The certification package CPL0 has the smallest depth of information, meaning the least amount of user data is analyzed with this package. In the example of FIG. 5B, the package CPL0 includes only publicly available information about the user 102. The certification package CPL1 includes the information of the CPL0 package and further includes Facebook, Twitter, and LinkedIn accounts of the user 102. Thus, the package CPL1 includes level L0 plus this additional user data and accordingly provides a greater depth of information on the user 102. The certification package CPL2 includes the prior levels L0 and L1 and further includes Instagram and email accounts of the user 102. In this way, the CPL2 package provides a still greater depth of information or more user data for analysis by the risk assessment system 100. The certification package CPL3 includes all the public and private data sources for the user 102 of the package CPL2, and further includes job Websites, iCloud accounts, and Amazon accounts for the user 102. The largest depth of information on the user 102 is accordingly accessed and analyzed through the selection of the certification package CPL3.

The five rightmost columns in Table 2 correspond to the subject matter categories previously discussed with reference to Table 1 in FIG. 4B, as indicated by the heading in the top row for each of these columns. The family or set of indices for each subject matter category is shown in the rows of these five columns, with the set of indicates for each category including one index for each certification package CPL0-CPL3. So when the certification package CPL0 is selected, for example, one corresponding index from each set of indices is generated. For example, when certification package CPL0 is selected, the indices CPI-L0, CSI-L0, ILSII-L0, GSCLI-L0, and CFI-L0 are generated for the privacy, security, health risk, government security level clearance, and general cyber presence composite subject matter categories, respectively. The depth of information for each of these indices is the depth L0 of certification package CPL0, and thus includes only public data for the user 102 in the example of FIG. 5B. The certification packages CPL0-CPL3 shown in Table 2 of FIG. 5B are merely examples of certification packages that may be used in the process 500 and in other embodiments of the present disclosure. Other certification packages including other subject matter categories and other types of user data may be used in place of or in combination with the certification packages CPL0-CPL3 shown in Table 2. Thus, in some embodiments there are more than four levels of certification packages CPL while in other embodiments there are fewer than four levels.

Returning now to FIG. 5A, the process 500 begins in operation 508 with the user 102 accessing the risk assessment 100. The process 500 the goes to operation 510 and prepares to generate a new report for the user 102, where the report will contain information for the user that is generated by the system 100, such as the subject matter indices and may include other information like tips and recommendations for the user to take to improve the values of the generated indices and thereby the risk profile of the user. From the operation 510 the process 500 the goes to the operation 512 and presents the user 102 with the option of selecting the desired certification package CPL0-CPL3. Other options may of course be presented to the user 102 in the operation 512. For example, the risk assessment system 100 may provide the user 102 with the option of selecting desired subject matter indices from among any of the available certification packages CPL0-CPL3 and not limit the user to only the default indices for a given certification package. In such an embodiment the user 102 could may, for example, select the level 0 privacy index CPI-L0, the level 1 security index CSI-L1, and the level 3 health, government security level clearance, and general cyber presence composite indices ILSII-L3, SCI-L3 and CFI-L3.

After the operation 512, the process 500 proceeds to the operation 514 and the privacy broker service and intelligence engine components of the risk assessment system 100 collects and processes the user data corresponding to the selected certification package or subject matter indices. Thus, as part of the operation 514 a sub operation 516 accesses publicly available data for the user 102 in operation 518. This publicly available data may be any data on the user 102 that is available to the general public, namely anyone having access to the Internet. A sub operation 520 collects private data on the user 102, assuming the user has selected a certification package CPL1-CPL3 where the user has agreed to grant the risk assessment system 100 access to at least some private data for the user. In an operation 522 the system 100 utilizes information provided by the user 102 to access and collect private data for the user. Private data is data for the user 102 that is available online but protected from access by the general public through some authentication, authorization or encryption technique. For example, the user 102 would provide his or her username and password for Facebook if the user selected the certification package CPL1 (FIG. 5B).

Once the system 100 has collected the required public and private data in operations 518 and 522, the system analyzes the collected data and generates the corresponding subject matter index or indices in sub operation 524. The sub operation 524 also checks to see whether any previous reports and corresponding indices for the user 102 have been generated. If such prior reports exist the sub operation 524 correlates the values of the newly generated indices with the prior values for these indices. The process 500 then proceeds to the operation 526 and builds a report that is presented to the user 102 for review in operation 528. As previously mentioned, this report may include a variety of different types of information along with the values of the generated subject matter indices for the user 102.

From the operation 528 the process then goes to operation 530 in which the user 102 either approves or rejects the newly generated report. Assuming the user is happy with the content of the generated report, the user 102 then approves the report in operation 530 in the process goes to operation 532 in the system 100 updates the subject matter indices for the user. The process 500 then goes to operation 534 and notifies content consumers that the user has authorized to access information contained in the generated report that a new report for the user has been generated and is available to the content consumer. The process 500 then proceeds to the operation 536 and terminates. Returning now to the operation 530, when the user 102 is not happy with the content of the newly generated report the user may reject the report in operation 530. In this situation, the operations 532 and 534 are not performed and the process proceeds immediately to the operation 536 and terminates without updating the values for the subject matter indices of the user and without notifying content consumers authorized by the user to view user data.

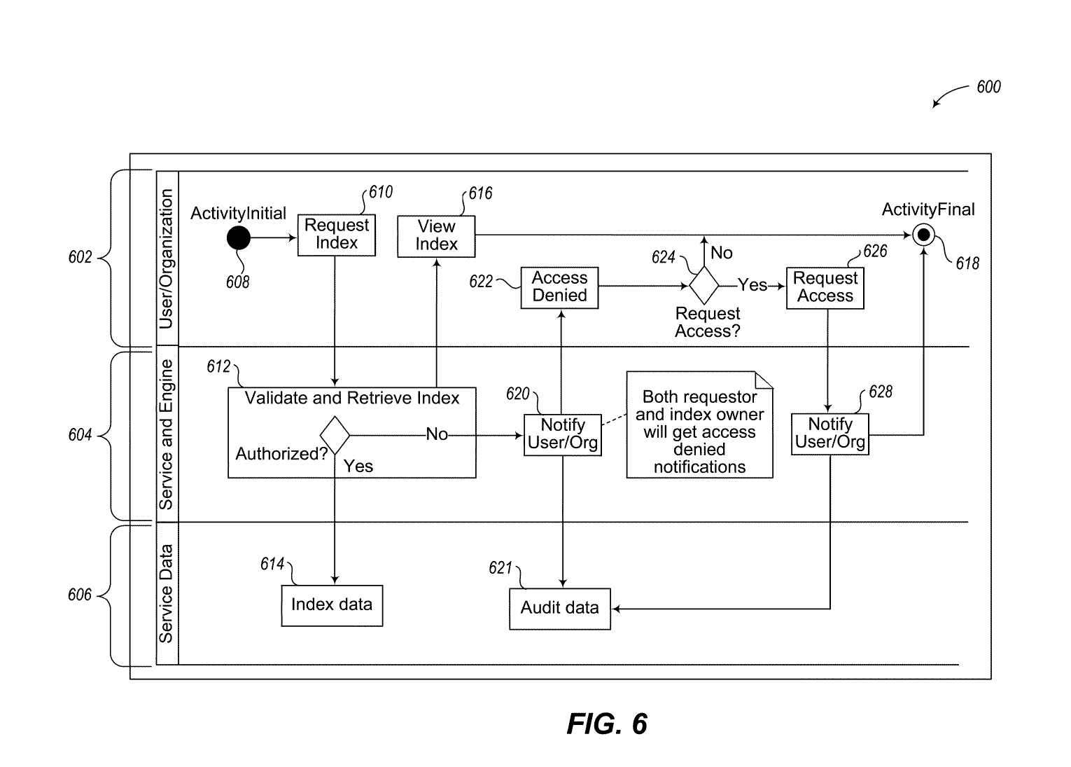

FIG. 6 is a flow diagram illustrating in more detail one embodiment of a process 600 through which a content consumer 108 (FIG. 1), such as an insurance company, requests information such as the generated subject matter indices for the user 102 from the risk assessment system 100. A top portion 602 of FIG. 6A illustrates interactions between the content consumer 108 and the risk management system 100. A middle portion 604 of FIG. 6A illustrates operations performed by the privacy broker service 401 and intelligence engine 110 components of the system 100. A bottom portion 506 of FIG. 5A represents the data generated by the risk assessment system 100 for the user 102, and for all users of the system, where this data is stored external to the system such as in the database 112 of FIG. 1.

The process 600 begins with operation 608 in which a content consumer 108 (FIG. 1) accesses the risk assessment system 100. This could occur, for example, in response to the content consumer 108 being notified by the system 100 in the operation 534 of FIG. 5A that new information for a given user 102 is available on the system. The process 600 then goes to operation 610 and the content consumer requests the values for a subject matter index or indices of a given user 102. From the operation 610 the process 600 goes to operation 612 and validates whether the content consumer is authorized to access the requested indices for the user 102. If the determination in operation 612 indicates the content consumer 108 is authorized, the process 600 then goes to the operation 614 and retrieves the corresponding index data for the user 102. In determining whether the content consumer 108 provided or denied access to the index data for the user 102, the operation 612 may also consider the identity and/or other information regarding the content consumer. Based on the identity and/or other information the process 600 may deny access to the content consumer 108 even where the user 102 has granted this content consumer access to the requested user data. For example, this may occur because the risk assessment system 100 (FIG. 1) may have determined that a particular content consumer 108 is a hacker or some other party intent on illegal/criminal activities. In this way, the process 600 protects users 102 from themselves where the user may think a given content consumer 108 is legitimate but the system 100 has determined otherwise. In such a situation, a notification could also be sent to the user 102 alerting them to this fact, such as in operation 620 which will be discussed in more detail below. The process 600 then goes to the operation 616 in the content consumer 108 is presented and allowed to view the requested index data for the user 102. At this point, after the content consumer 108 is done retrieving or viewing the requested index data for the user 102 the process 600 goes to the operation 618 and terminates.

When the determination by the operation 612 is negative, meaning the content consumer 108 is not authorized to retrieve the requested index data for the user 102, the process 600 then goes to the operation 620 and notifies both the user and the content consumer that access to the user index data has been denied. In this way the user 102 is made aware that an unauthorized content consumer 108 has attempted to access index data for the user. The user 102 may then take appropriate action, such as granting the content consumer access where the content consumer is a party that the user may want to allow to access and consider the users index data. The user 102 could alternatively contact the content consumer 108 to ask why that content consumer is attempting to access the user's index data.

From the operation 620, the process 600 goes to operation 621 and stores a record of the attempted access of the user index data by the content consumer 108. The process 600 also goes from the operation 622 operation 622 and provides the notification to the content consumer 108 that access has been denied. From the operation 622 process 600 then goes to the operation 624 and gives the content consumer 108 the option of requesting authorization from the user 102 to access the user index data for which the content consumer has just been denied access. If the content consumer 108 indicates in the operation 624 that no such access request is desired, the process 600 then goes to the operation 618 and terminates. In contrast, when the content consumer 108 desires access, the determination by the operation 624 is positive and the process proceeds to the operation 626 and generates an access request. From operation 626 the process 600 goes to the operation 628 and notifies the user 102 of the access request from the content consumer 108. From the operation 628, the process 600 once again goes to the operation 621 and stores a record of the request for access to the user index data by the content consumer 108. From the operation 628 the process 600 then also goes to the operation 618 and terminates.

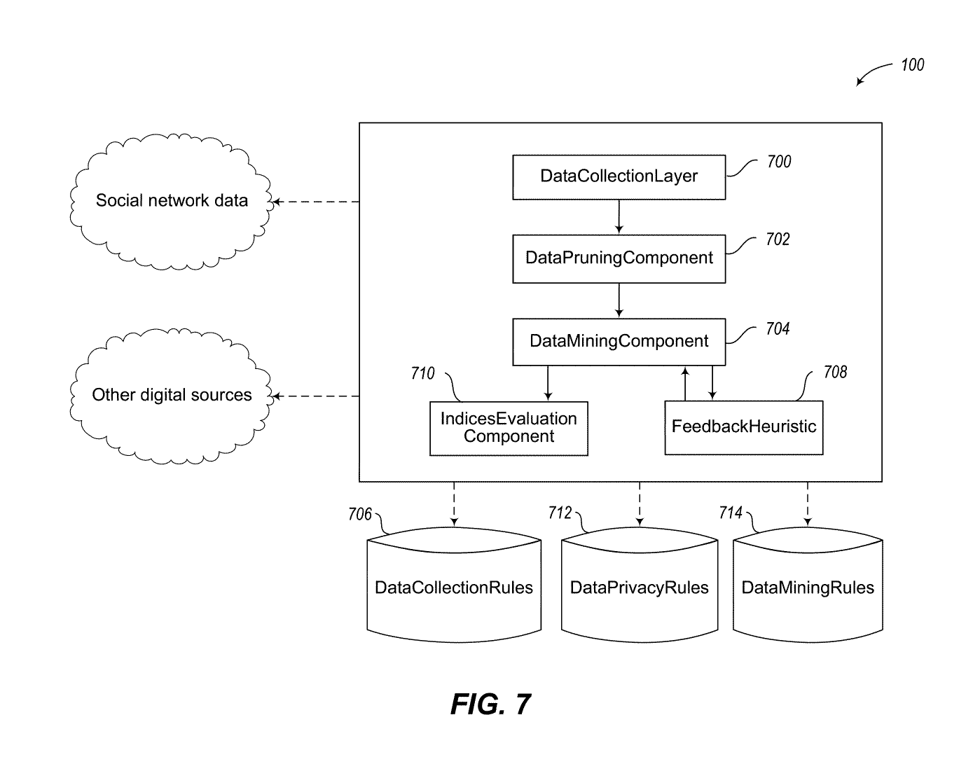

FIG. 7 is a more detailed functional block diagram of one embodiment of the risk assessment system 100 of FIG. 1. In the embodiment of FIG. 7, the risk assessment system 100 includes a data collection layer component 700 that collects data from the users 102. Security and trust of users is extremely important and therefore collecting public and private user data from the various online sources must be done in a secure manner. This acceptance and trust by users 102 are required for commercial success of the risk assessment system 100. In one embodiment, the data collection layer component 700 utilizes industry standard security techniques to securely access the required user data.

To achieve these objectives regarding security and trust of users 102, in one embodiment no accessed user data is stored by the risk assessment system 100. In some embodiments, however, the risk assessment system 100 may store data for the purpose of continuing assessment of risk of a user 102. This would be an option selected by the user 102 when establishing an account on the risk assessment system 100. Where such data is stored by the system 100, the stored data will be an abstraction of the user data retrieved by the system, such as by hashing and/or encrypting the user data using suitable industry standard algorithms, such as the Open PGP standard, for example. The stored data must be capable of being utilized by the system 100 in the future for the desired purposes, such as for the continuing assessment of risk of the user 102. Moreover, the stored data must be sufficiently abstracted so as to hide the specific source of the stored data such that the abstraction process could not be reversed to identify the source of the data.

In the embodiment of the risk assessment system 100 of FIG. 7, a data pruning component 702 receives the collected user data from the data collection layer component 700 and removes redundant and irrelevant data from the collected data. A data mining component 704 thereafter receives the pruned or processed the data from the data pruning component 702 and utilizes directed and undirected data mining and big data algorithms to process this data. As part of processing the data, the data mining component 704 builds and detects patterns in the collected user data and utilizes the process data to contribute to a set of global rules and models stored in a data collection rules database 706. The aggregate of processed data from multiple users 102 is used so that the rules and models stored in the database 706 are continuously updated. Data from new users of the system 100 will in this way will incrementally improve the precision of the indices generated by the system.

A feedback heuristic component 708 integrates the insight gleamed from user data for the multiple users 102 of the system 100 into a global model for use in generating the subject matter indices. A data mining rules component 710 stores data mining rules that the data mining component 704 utilizes in processing the pruned collected user data. In addition, a feedback heuristic component 708 receives data from the data mining component 704 and operates to adjust data mining algorithms utilized by the data mining component. An indices evaluation component 710 processes the data from the data mining component 704 to calculate the subject matter indices using the rules stored in the rules stored in the data collection rules database 706 along with rules stored in a data privacy rules database 712 and data mining rules database 714.

The risk assessment system 100 enables the creation of new products and services in the insurance evaluation and rating industry. For users 102, which may be individual insurance shoppers and policyholders, the risk assessment system offers these consumers a way to reduce their risk resulting from their online activities. The system 100 also safely transmits data to content consumers such as insurance agencies or carriers that would provide a basis for an insurance agency or carrier to provide more favorable policy terms to the user without compromising privacy of the user. No private data of the user 102 need be provided to the insurance agency or carrier. The user 102 need only grant access to the generated subject matter indices generated by the system 100 for the user. Similarly, the risk assessment system 100 provides advantages from the insurance the agency and carrier perspective. The risk assessment system 100 provide the agencies and carriers with a way to more effectively determine or assess the appropriate level of risk exposure for a given user 102 based on user behaviors, traits, relationships, preferences and activities as gleaned from the public and private data for the user that is analyzed by the system. These sources of user data supplement conventional source of user data typically utilized by insurance agencies and carriers, such as driving records, medical history, and so on. The risk assessment system 100 provides these agencies and carries 108 with access to otherwise unobtainable data for a user 102. Moreover, this data is made available to the agencies and carriers 108 in privacy-protected or anonymous form using the generated subject matter indices for the user and other types of user-related disclosure that may be provided by the system 100.

Some embodiments of the risk assessment system 100 address the concern of users “fudging” or fabricating ostensibly valid user data. For example, the user 102 may create dummy user accounts to improve the values of the generated subject matter indices for the user 102 while keeping real accounts of the user undisclosed to the system 100. One embodiment addresses this potential issue by taking into account the length of time that a given account of the user 102 has existed along with the amount or quality of the information from such an account. These factors are utilized in adjusting the values of the generated subject matter indices for the user to reduce the impact of such accounts on the values of the generated indices.

Several use scenarios for the risk assessment system 100 will now be provided.

### EXAMPLE 1

### Certifiable Entities Scenario

An individual consumer called Bob has the following accounts, online presence (e-presence), and installed software on his computer(s) and mobile devices.

Email accounts: Yahoo, Hotmail, Gmail Social networking accounts: Facebook, Twitter, LinkedIn, Wordpress.com blog.

Streaming media: Netflix, Amazon Digital Video

Cloud accounts: DropBox, Google Drive

Jobs websites: Monster, theLadder.

Financial activity: online banking, bill-pay, Quicken

Health/fitness tracking: Fitbit, NikeFuel, Apple Watch

Internet-connected software: Chrome and Firefox browsers (laptop); Safari (mobile device)

Use Case A

Bob wishes to purchase a health or life insurance policy at a better rate than is currently available to him. He is not a candidate for the most preferential rates through normal channels because he has a history of smoking in the last 3 years.

Scenario for Use Case A:

Bob chooses to establish an account through an eco-system portal. He authorizes the system to mine his Facebook, Fitbit, and Quicken account data so that he can show evidence of a healthy lifestyle.

The system validates that his Facebook account shows photos or images of him riding bikes with friends and hiking in the local mountains with confirmed GPS coordinates. The system further examines his exercise and sleep habits via Fitbit, and creates a sub-index based on his restaurant attendance patterns to probabilistically assess the type of foods and volume of alcohol he is likely to consume.

Based on the collected data, the system compares Bob's health and lifestyle habits to reference values for example averages for various health and/or lifestyle categories. If the system determines that Bob's averages are above-average, and the system may grant him a certification and score that allows him to buy a health or life insurance policy at preferred rates.

Use Case B

Bob wishes to determine which types of security and privacy threats he may be facing as a result of his browsing, purchasing and social networking activities, and gain an assessment of his risk profile.

Base context for Use Case B:

Facebook already monitors Bob's social graph and posts, and uses his correspondence and “likes” to determine preferences, a valuable piece of information for marketing.

Amazon is continuously evaluating Bob's purchase and streaming history to construct a consumer profile to better target products.

Various financial service providers use Bob's purchasing data to push and/or deny financial products and other services to him.

Heightened context for Use Case B:

A sophisticated phishing scheme has targeted a close relative, and so Bob wants to understand his own exposure. He is worried that if hackers have already gained access to his Facebook account, they may be able to figure out his email password and extend their reach using data mining tools and social engineering.

A “cyber bodyguard”, based on the simulated disclosure concept referenced in Table 3 above, would help Bob assess his exposure by analyzing all these accounts and subsequently returning to Bob:

The system can generate and provide a list of indices capturing a picture of Bob's cyber footprint, along with associated threat levels and privacy scores

Based on the assessment the system may provide a list of suggested actions Bob can take to reduce his risk

The system may additionally or alternatively provide a secondary exposure profile, for instance in the form of a list which indicates or identifies Bob's social network relations which if compromised would likely cause direct harm to Bob.

Additionally, and with Bob's permission, the system could periodically re-analyze Bob's exposure and notify him when conditions change beyond a defined threshold or user-selected point.

Further Observations about Example 1: For many users, the individual cyber exposure index will serve a similar purpose as purchasing a credit report and credit score from one of the large credit bureaus. There is, however, a critical difference. Whereas a credit score is publicly available, any score generated by this system will be sole property of the user. He or she is in full control at all times, and may disclose or revoke disclosure to other individual entities or organizations at his/her discretion and at any time.

The range of entities that may have an interest in consuming the certified index or indices is potentially broad. For instance, an employer may have certain job categories for whom candidates with spotless backgrounds and low privacy/security/behavior risk is attractive. Examples may include: a controller, auditor, or spokesperson. Job candidates could stand out in the recruiting process by voluntarily providing index scores. Also for example, individuals could be required to provide a validated privacy or health score as a condition of candidacy or employment, particularly for very high-profile leadership roles (e.g. top executives of public companies, candidates for sensitive appointed or elected office). As a further example, government entities who are charged with protecting non-public information may choose to incorporate key indices in the security clearance process. As even a further example, subscribers to dating sites may choose to obtain and post their index results as a way to stand out from the crowd.

### EXAMPLE 2

### Content Consumer or Examiner's Scenario

An insurance company, General Direct, decides to integrate a lifestyle index in its rates calculations, and offer discount for customers providing access to their index.

Use Case C:

Priya is a female consumer who is shopping for auto insurance.

If Priya trusts General Direct and has heard from friends that they have competitive rates as well as good claims payment practices, she may use the link on General Direct's application page to reach the Broker system and obtain an appropriate lifestyle index.

Since the Broker system can employ Application Programming Interface (APIs) from external providers, General Direct could make their quoting engine available. In this case, the system may provide Priya with an estimated discount rate before General Direct ever sees her application, further enhancing her control and privacy.

It's also possible that if Priya has an existing policy with General Direct, she could allow the insurer to generate a custom, proprietary index score on her behalf using the policy and claims data that General Direct already has. This “white labeled” score could be used to obtain preferential rates in General Direct's other insurance lines, or be shared with General Direct's partners, with her permission, in a way that maintains Priya's privacy and control.

Use Case D:

Acme Industries, Inc. carries Directors and Officers Liability Insurance (“D&O”) to protect the organization as well as individual executives and board members from liability claims. Acme's SVP of HR and Benefits knows that by obtaining a lifestyle index score for its CEO, the company can dramatically reduce the policy premium charged by General Direct. Because of the system's architecture, each individual can go through the assessment and subsequently choose to share or not share his or her index with Acme, General Direct, or both.

It could also be possible for the system to allow for the creation of indices for corporations, fiduciaries, and other legal persons based on publically and/or commercially available data.

The concept of simulated exposure described earlier could also apply to this use case. Acme could request ad-hoc or scheduled re-assessments of their exposure, as could the CEO herself. It is also possible that Acme could authorize the insurer carrying their D&O policy to undertake periodic re-assessments during the policy period, on the basis of receiving a reduced premium or other considerations. The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory. The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operation in a risk assessment system to assess risk associated with users based at least in part on online presence, the risk assessment system comprising at least one processor and at least one processor-readable storage medium communicatively coupled to the at least one processor and that stores at least one of processor-executable instructions or data, the method comprising:
accessing publicly available online data specific to a first user;
accessing privately available online data specific to the first user, the privately available online data only available via authorization granted via the first user;
based at least in part on the accessed publicly and privately available online data for the first user, generating, by the at least one processor, a respective value specific to the first user for each of at least one subject matter index, the respective value indicative of an amount of risk associated with the first user based on a respective set of subject matter criteria for the respective subject matter index.

2. The method of claim 1 wherein accessing publicly available online data specific to a first user includes at least one of: i) accessing information on a publicly accessible online account which was identified by the first user, or ii) accessing information on a publicly accessible online account which was not identified by the first user.

3. The method of claim 1 wherein accessing privately available online data specific to the first user includes at least one of: i) accessing information on a private online account for which the first user has granted access permission, or i) accessing information on a private online account for which the first user has provided at least one piece of information required to access the private online account.

4. The method of claim 1 wherein generating a respective value specific to the first user for each of at least one subject matter index includes generating a respective value for at least one of: a cyber-privacy index based on a set of cyber-privacy criteria, a cyber-security index based on a set of cyber-security criteria, a government security clearance index based on a set of government security clearance criteria, a cyber-exposure index based on a set of cyber-exposure criteria, a cyber-footprint index based on a set of cyber-footprint criteria, or an electronic safety history index based on a set of historical electronic security criteria.

5. The method of claim 1 wherein generating a respective value specific to the first user for each of at least one subject matter index includes generating a respective value for a lifestyle index based on a set of individual lifestyle criteria.

6. The method of claim 1 wherein generating a respective value specific to the first user for each of at least one subject matter index includes generating a respective value based on subject matter criteria indicative of at least one of behaviors, traits, relationships, preferences, or activities as assessed from publicly and privately available online data.

7. The method of claim 1 wherein generating a respective value specific to the first user for each of at least one subject matter index includes aggregating information from across a number of publically and privately available online resources.

8. The method of claim 7 wherein generating a respective value specific to the first user for each of at least one subject matter index further includes for at least one piece of information, cross-checking the piece of information between at least two different ones of the publically and privately available online resources.

9. The method of claim 7 wherein generating a respective value specific to the first user for each of at least one subject matter index further includes for at least one piece of information, determining at least one of: i) how recently the piece of information was made available, or ii) how old is the publically or privately available online resource from which the respective piece of information was derived; and assessing a reliability of the respective piece of information based on the determination regarding how recently the piece of information was made available, or how old is the publically or privately available online resource from which the respective piece of information was derived.

10. The method of claim 7 wherein generating a respective value specific to the first user for each of at least one subject matter index further includes for at least one piece of information, assessing how extensively populated is the publically or privately available online resource from which the respective piece of information was derived, and assessing a reliability of the respective piece of information based on the assessment of how extensively populated is the publically or privately available online resource from which the respective piece of information was derived.

11. The method of claim 1 wherein generating a respective value specific to the first user for each of at least one subject matter index includes aggregating information including postings and images from across a number of publically and privately available online resources.

12. The method of claim 11 wherein generating a respective value specific to the first user for each of at least one subject matter index includes generating a respective value for a lifestyle index based on a set of individual lifestyle criteria based at least in part on online postings or images which represent the first user engaged in at least one of: i) an unhealthy behavior, or ii) a risky activity.

13. The method of claim 12 wherein generating a respective value for a lifestyle index based on a set of individual lifestyle criteria further includes assessing an apparent frequency of at least one of: an unhealthy behavior, or a risky engaged in by the first user based at least in part on the online postings an images.

14. The method of claim 1, further comprising:
receiving permission specification information, by the at least one processor, for the first user that specifies at least one level of permission to access at least the respective value specific to the first user for each of at least one subject matter index.

15. The method of claim 14 wherein receiving permission specification information for the first user includes receiving permission specification information for the first user that specifies a first level of permission for access to a first subject matter index and a second level of permission for access to a second subject matter index, the second subject matter index different from the first subject matter index.

16. The method of claim 14 wherein receiving permission specification information for the first user includes receiving permission specification information for the first user that specifies a first level of permission for access to a first subject matter index and a second level of permission for access to a specific information from which the first subject matter index was derived.

17. The method of claim 14 wherein receiving permission specification information for the first user includes receiving permission specification information for the first user from the first user that specifies a first level of permission for access to information based on at least one of: i) a defined context, ii) a defined purpose, or iii) a defined period of time.

18. The method of claim 14, further comprising:
causing a presentation of a set of certification packages that are available to choose from.

19. The method of claim 14, further comprising:
causing a presentation of a set of subject matter indices that are available to choose from.

20. The method of claim 14, further comprising:
causing a presentation of at least one of: i) a set of certification packages that are available to choose, or ii) a set of subject matter indices that are available to choose from; and
wherein receiving permission specification information includes receiving a selection of at least one of: i) one of the certification packages, or ii) one of subject matter indices.

21-26. (canceled)

27. A risk assessment system to assess risk associated with users based at least in part on online presence, the risk assessment system comprising:
at least one processor;
at least one processor-readable storage medium communicatively coupled to the at least one processor and that stores at least one of processor-executable instructions or data that, when executed by the at least one processor, cause the at least one processor to function as a risk assessment system that:
accesses publicly available online data specific to a first user;
accesses privately available online data specific to the first user, the privately available online data only available via authorization granted via the first user;
generates, based at least in part on the accessed publicly and privately available online data for the first user, a respective value specific to the first user for each of at least one subject matter index, the respective value indicative of an amount of risk associated with the first user based on a respective set of subject matter criteria for the respective subject matter index.

28-52. (canceled)

53. A method of assessing online exposure of a user, the method comprising:
receiving user selection data defining the types of user data to be included in assessing online exposure of the user;
collecting online user data based upon the user selection data;
generating at least one user index based on the collected online user data, each user index providing an indication of an aspect of the online exposure of the user while maintaining the anonymity of the user;
receiving user authorization data that establishes permissions defining access to the generated user indexes; and
providing or denying access to each generated user index based upon the user authorization data.

54-72. (canceled)
